(19) United States
(12) Patent Application Publication
(10) Pub. No.: US 2008/0019767 A1
(43) Pub. Date: Jan. 24, 2008

(54) Structural Component Connection

(75) Inventors: Michael R. Bittner, Canton, MI (US); Ronald G. Bedro, Plymouth, MI (US); Scott A. Profozich, Canton, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/720,248

(22) PCT Filed: Nov. 29, 2005
(86) PCT No.: PCT/US05/42917

§ 371 Date: Jun. 19, 2007

Related U.S. Application Data
(60) Provisional application No. 60/632,741, filed on Nov. 30, 2004.

(51) Int. Cl. B60N 2/68; B23K 11/14; B23K 23/00; B60N 2/22

(52) U.S. Cl. 403/270; 297/354.1

(57) ABSTRACT

A connection assembly suitable for coupling a first component (42) to a second component (80) is provided. The connection assembly includes a first component having a projection (46). The projection has a peripheral surface that outwardly extends from the first component in a nonlinear manner. The connection assembly further includes a second component defining an aperture (86) for receiving the projection.

### CROSS-REFERENCE TO RELATED PATENT APPLICATIONS

This application claims the benefit under 35 U.S.C. § 119(e) of U.S. Provisional application No. 60/632,741, entitled “Structural Component Connection,” filed Nov. 30, 2004, the disclosure of which is incorporated herein by reference in its entirety.

### BACKGROUND

The present invention relates generally to the field of structural component connections for vehicles (e.g., automobiles such as cars, trucks, sport utility vehicles, recreation vehicles, and the like; airplanes, boats, etc.). More particularly, the present invention relates to a structural component connection suitable for coupling components of a vehicle seat recliner to an element of a seat frame.

In a number of vehicular applications, it is often necessary to rigidly couple one structural vehicle component having a relatively planar mating surface to a second structural vehicle component having a complimentary mating surface. For example, in vehicle seating it is often desirable to rigidly couple a component of a recliner mechanism to a component of a seat frame. It is known that the recliner component can be coupled to an exterior facing surface of a seat side member, typically by the use of welding or of fasteners (e.g., bolts, rivets, etc.).

It is also known to combine coupling techniques when coupling a recliner component to a component of a seat frame. For example, it is known to couple a recliner component to a component of a seat frame by both welding and by a positive mechanical lock. In this instance, the latter is created by a beveled projecting part on the recliner component in the shape of a truncated cone or a triangular projection. The circumferential surfaces of the truncated cone and triangular projection outwardly extend as inclined linear surfaces (i.e., beveled projections). During assembly, the projecting part is pressed into an opening in the seat component while a welding process takes place.

It is further known to provide a collection pocket on one of the recliner component or the component of the seat for receiving material which is melted and displaced during the welding process. For example, it is known to provide a collection pocket configured as a continuous annular groove in the face of the recliner component or in the face of the component of the seat.

While it is known to couple a recliner component to a component of a seat frame by both welding and by a positive mechanical lock, and to provide a collection pocket, these known systems are limited to a connection utilizing a beveled surface. While such a flat or straight line (i.e., linear) surface is known, a significant advance in the art of connections and vehicle seating would occur if an improved connection could be developed for coupling together two or more structural components. Such a connection would preferably provide an enlarged welding surface and material between the structural components, a stronger positive mechanical interlock between the structural components, and/or an improved system for collecting material displaced during the coupling process.

### SUMMARY

According to one embodiment, a connection assembly for coupling a first component to a second component (such as a vehicle seat recliner to one or more elements of a seat frame) includes a projection outwardly extending from the first component. The projection is configured to at least partially be received by an aperture defined by the second component. The projection includes a peripheral surface that outwardly extends as a nonlinear (e.g., curvilinear) projection from the first component.

In such an embodiment, the peripheral surface may extend between a base having a first cross section and a end face having a second cross section. According to an exemplary embodiment, the first cross section is larger than the second cross section and a cross section of the aperture. According to another exemplary embodiment, the peripheral surface has a hemispherical shape. According to another exemplary embodiment, the peripheral surface has a truncated hemispherical shape.

According to another embodiment, the connection just described further includes a collection system suitable for receiving material displaced during a welding process. The collection system includes a collection recess at least partially surrounding the projection and the aperture when the projection penetrates the aperture.

The collection recess may comprises a single continuous groove in at least one of the first component and the second component, or may be defined by a plurality of segments in both the first component and the second component. For the latter, neither the first component nor second component alone defines collection recess. Instead, the collection recess is formed when the first component is adjacently positioned with the second component. According to an exemplary embodiment, the first component carries a first pair of crescent-shaped segments and the second component carries a second pair of crescent-shaped segments.

According to a further embodiment, a method for coupling a first component to a second component includes the step of pressing a projection provided on the first component into an aperture provided in the second component. The method further includes the step of welding the first component to the second component. The projection includes a peripheral surface that outwardly extends as a non-linear projection from the first component. Configuring the peripheral surface as a non-linear projection may enlarge the available welding surface on the projection.

### BRIEF DESCRIPTION OF THE DRAWINGS

FIG. 1 is a perspective view of a component of a seat recliner coupled to a component of a seat frame according to one exemplary embodiment.

FIG. 2 is an exploded perspective view of the components of FIG. 1.

FIG. 3 is a cross-section view of the first structural component of FIG. 2, taken along the line 3-3.

FIG. 4 is another perspective view of the second structural component of FIG. 2.

FIG. 5a is a perspective view of a projection according to one exemplary embodiment.

FIG. 5b is a cross-section view of the projection of FIG. 5a.

FIG. 6a is a perspective view of a projection according to another exemplary embodiment.

FIG. 6b is a cross-section view of the projection of FIG. 6a.

FIG. 7a is a perspective view of a projection according to another exemplary embodiment.

FIG. 7b is a cross-section view of the projection of FIG. 7a.

FIG. 8a is a perspective view of a projection according to another exemplary embodiment.

FIG. 8b is a cross-section view of the projection of FIG. 8a.

FIG. 9a is a top plan view of a collection system according to one exemplary embodiment.

FIG. 9b is a cross-section view of the collection system of FIG. 9a, taken along the line 9-9.

FIGS. 10 is a top plan view of a collection system according to another exemplary embodiment.

FIGS. 11a through 11c are side views showing sequentially the coupling of the first structural component to the second structural component.

### DETAILED DESCRIPTION

Referring generally to the FIGURES, a structural connection (connection, engagement, coupling configuration, etc.) suitable for coupling together two or more structural components is provided. Generally, the connection combines the use of a welding process with a positive mechanical engagement (e.g., interlock, lock, etc.) to sufficiently couple together two or more components. The positive mechanical engagement between the components is intended to reinforce a weld seam (area of weldment) between the components and/or to increase the available weld surface. The combination can provide a connection that simplifies manufacturing and improves the strength of the connection.

The structural connection is shown and described herein as a connection 10 suitable for coupling together two or more vehicle components. In particular, connection 10 is shown and described herein as a connection suitable for coupling a component of a rotary seat recliner to a component of a vehicle seat. Connection 10 is useful in all types of vehicle seating applications where it is desirable to prevent one component from being significantly displaced with respect to another under a load, impact or impulse force.

It should be noted that connection 10 is not limited to vehicle seating applications, and may be useful in any of a variety of vehicular applications wherein two or more components are to be secured relative to each other. Connection 10 may also be used in non-vehicular applications. For example, connection 10 may find utility in applications such as office furniture, machinery, or any other application where it is desirable to couple together structural components having relatively planar mating surfaces.

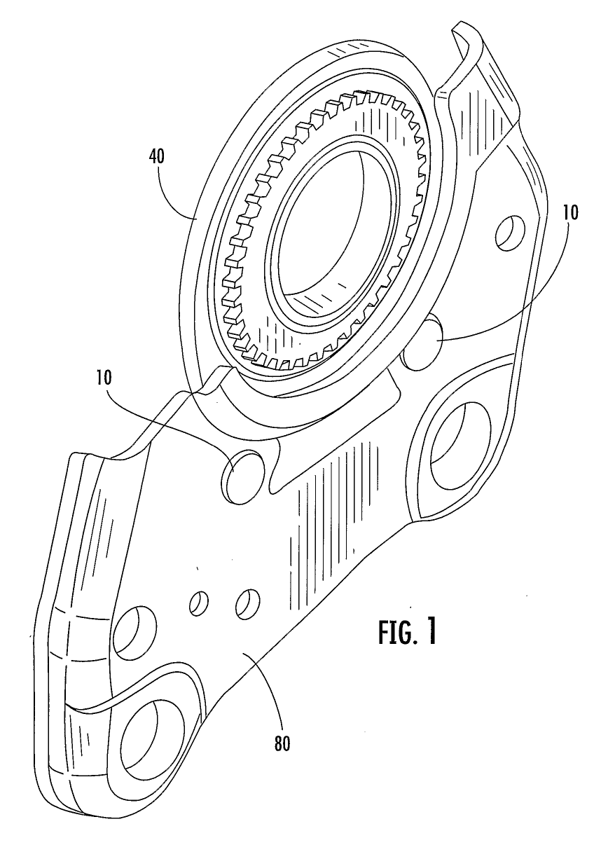

FIG. 1 shows a component of a vehicle seat recliner mechanism (shown as a first recliner component 40) coupled to a component of a vehicle seat frame (shown as a first plate 80) at a plurality of connections 10. A wide variety of recliner mechanisms and vehicle seat frames are known and the illustration of the first recliner component 40 and the first plate 80 are not intended to be limiting. Connection 10 may be used to couple any of a number of recliner mechanisms and vehicle seat frames.

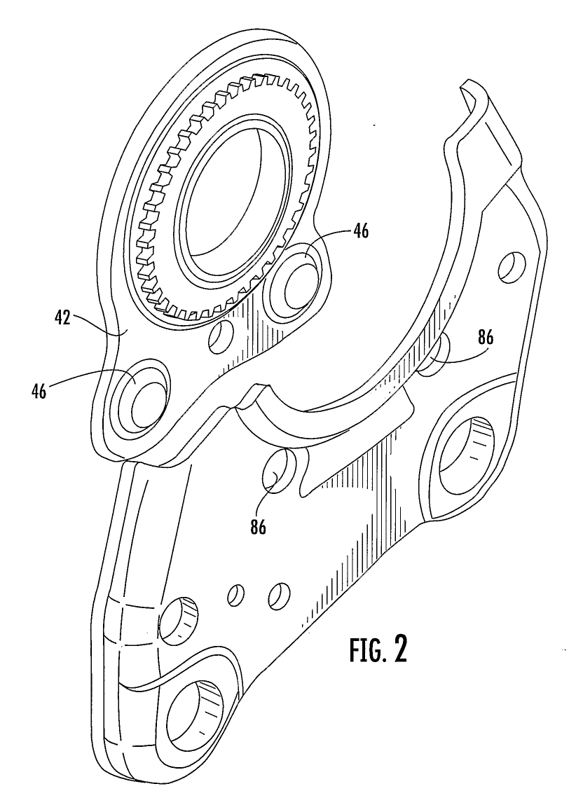

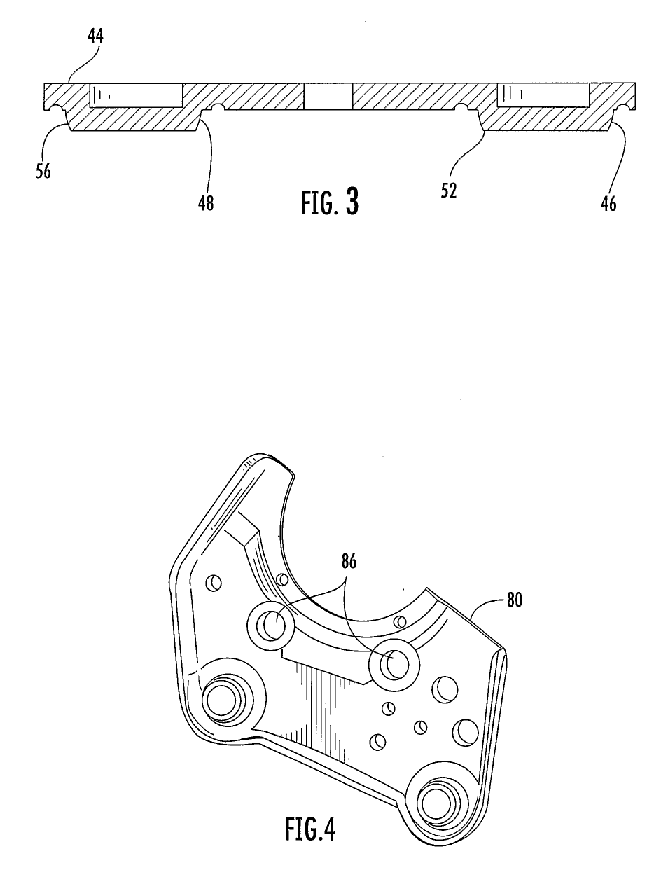

First recliner component 40 is shown as being configured to be coupled to first plate 80 at two connections 10. First recliner component 40 includes a first surface (e.g., inner, inboard, etc.), shown as a first mating surface 42, and a second surface (e.g., outer, outboard. etc.), shown in FIG. 3 as an outer surface 44. First recliner component 40 is preferably formed from a relatively flat metallic sheet, such as steel, which is stamped and/or punched to achieve the desired shape, but alternatively may be fabricated from any of a variety of suitable materials.

Referring to FIG. 2, first recliner component 40 includes at least one projection 46 outwardly extending from first mating surface 42. Projection 46 is used for coupling first recliner component 40 to first plate 80. Projection 46 is configured to engage an aperture 86 provided in first plate 80 and allow for a positive mechanical interlock for connection 10. First recliner component 40 may include any number of projections 46 depending on the application and the material being used. The number of projections 46 corresponds to the number of connections 10. According to one exemplary embodiment, first recliner component 40 includes two projections 46.

Referring to FIG. 3, projection 46 outwardly extends from first mating surface 42. Projection 46 extends between a base 48 having a first or proximal cross section and a distal end portion (e.g., tip, etc.), shown as an end face 52, having a second or end cross section. Cross section of projection 46 near base 48 is larger than cross section of projection 46 near end face 52. In this instance, projection 46 has a peripheral surface 56 that narrows at a changing rate as it outwardly projects from base 48 to end face 52.

According to one exemplary embodiment, projection 46 maintains a substantially circular cross section as it outwardly extends from base 48 to end face 52. For such a configuration, the diameter of projection 46 is greater near base 48 than near end face 52. The cross sectional shape of projection 46 is not limited to substantially circular cross sections. For example, projection 46 may have a cross sectional that is substantially polygonal in shape with curvilinear sides. In addition, projection 46 may be shaped as a projection having a cross section varying in shape, in addition to size, as it extends between base 48 and end face 52.

According to the present invention, peripheral surface 56 does not outwardly extend as a linear projection (such as a bevel or cone), but instead outwardly extends as a non-linear (e.g., curvilinear) projection. Providing a projection 46 having a peripheral surface 56 that outwardly extends as a non-linear projection rather than as a linear projection advantageously allows for an improved connection 10. The surface area of a projection 46 having a peripheral surface 56 that outwardly extends as a non-linear projection is greater than the surface area of a similar projection extending as a linear projection.

While not intending to be limited by any particular theory, it is believed that the enlarged surface area of peripheral surface 56 increases the interface (i.e., the region of contact) between first recliner component 40 and first plate 80 and/or increases the available weld surface on projection 46. Either consequence would allow for a connection 10 having increased strength in comparison to a connection formed with a beveled projection having a circumferential or peripheral surface that extends as a linear projection. By providing a non-linear (e.g., rounded, etc.) projection 46 configured to increase the interface between first recliner component 40 and first plate 80, a positive mechanical interlock having improved strength can be achieved. By providing a projection 46 configured to increase the available weld surface, a weldment having improved strength is achieved.

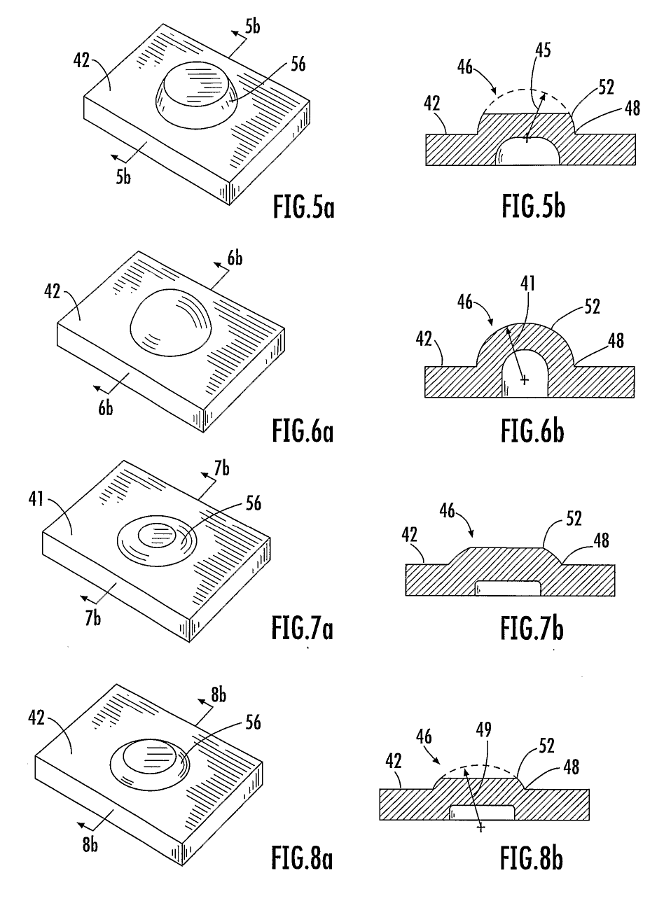

Peripheral surface 56 of projection 46 may be configured in a variety of non-linear profiles (e.g., curvilinear profiles, stepped profiles, etc.). For example, peripheral surface 56 may include convex portions (see FIGS. 5a through 8b), concave portions, and/or stepped portions. Peripheral surface 56 may be a continuous solid, or alternatively may include ribs, annular grooves, or any other feature that disrupts the continuity of peripheral surface 56. In addition, end face 52 may be a solid surface (as shown), or alternatively may include one or more apertures (not shown) that may be beneficial for the stamping process or improve heat dissipation during the welding process. Projection 46, similar to the other features of first recliner component 40, is preferably formed by a stamping or pressing process. Referring to FIGS. 5a through 8b, a number of suitable shapes for projection 46 are shown. It should be clearly understood that projection 46 is not limited to the embodiments illustrated, and may include any peripheral surface that extends in a non-linear manner from first mating surface 42.

According to one exemplary embodiment, shown in FIGS. 5a and 5b, projection 46 is shown configured as a truncated hemisphere. Projection 46 narrows as it outwardly extends between base 48 of the truncated or frusto-hemisphere and end face 52 of the truncated hemisphere. In such an embodiment, end face 52 is a relatively flat surface. Projection 46 is shown as having a radius 45 with a center provided substantially near a plane defined by first mating surface 42.

According to another suitable embodiment, shown in FIGS. 6a and 6b, projection 46 is shown configured as a hemisphere. Projection 46 narrows as it outwardly extends between base 48 of the hemisphere and end face 52 of the hemisphere. In such an embodiment, end face 52 is a relatively curved surface. Similar to the embodiment shown in FIGS. 5a and 5b, projection 46 is shown as having a radius 47 with a center provided substantially near a plane defined by first mating surface 42.

According to another suitable embodiment, shown in FIGS. 7a and 7b, projection 46 is shown configured as a truncated ellipsoid. Projection 46 narrows as it outwardly extends between base 48 of the truncated ellipsoid and end face 52 of the truncated ellipsoid. In such an embodiment, end face 52 is a relatively flat surface.

According to another suitable embodiment, shown in FIGS. 8a and 8b, projection 46 is shown configured as a partial truncated hemisphere. Projection 46 narrows as it outwardly extends between base 48 of the partial truncated hemisphere and end face 52 of the partial truncated hemisphere. In such an embodiment, end face 52 is a relatively flat surface. Projection 46 is shown as having a radius 49 with a center provided below a plane defined by first mating surface 42.

As mentioned above, projection 46 is configured to engage (e.g., penetrate, be inserted into, etc.) a component of a vehicle seat frame to provide connection 10. Referring further to FIG. 1, first recliner component 40 is shown as being coupled to first plate 80 (e.g., seat frame, platform, member, etc.). First plate 80 supports first recliner component 40 relative to a seat frame. First plate 80 may be integrally formed as a single unitary body with a seat frame, or alternatively may be a separate member that is coupled to a seat frame.

Referring further to FIG. 2, first plate 80 is shown as a member separate from a seat frame, and is preferably formed from a relatively flat metallic sheet, such as steel or aluminum, which is stamped and/or punched to achieve the desired shape. First plate 80 can have any suitable number and shapes of ridges and apertures to improve rigidity and/or reduce weight. First plate 80 is generally defined by a first surface (e.g., side, wall, face, etc.), shown in FIG. 4 as a second mating surface 82, and a second surface 85 (e.g., side, wall, face, etc.). Second mating surface 82 faces first mating surface 42 of first recliner component 40, while the second surface 85 is configured to face a side portion of the seat back frame.

Referring further to FIG. 4, first plate 80 is shown having a geometry that allows first plate 80 to move (e.g., rotate, etc.) in a plane that is at least partially occupied by a portion of a recliner mechanism. Particularly, first plate 80 includes an arc-shaped edge 83 near an lower region of first plate 80. Arc-shaped edge 83 corresponds to the curvature of the recliner mechanism to allow for the articulated movement of the recliner mechanism and/or the first plate 80 (and a corresponding seat back).

First plate 80 is further shown as including at least one aperture 86 (e.g., opening, recess, depression, cavity, etc.) disposed in second mating surface 82. Aperture 86 is configured to receive projection 46 when first recliner component 40 is coupled to first plate 80. Aperture 86 may be configured as a bore or opening that extends completely through first plate 80, or alternatively may be configured as a recess or depression that only extends partially through first plate 80. According to one exemplary embodiment, aperture 86 is an opening that extends from second mating surface 82 to second surface 85

Aperture 86 is shown as being defined by a sidewall 87. Sidewall 87 constitutes a circumferential surface that is engaged or otherwise contacted by projection 46 when first recliner component 40 is coupled to first plate 80. According to a preferred embodiment, the shape (i.e., geometry) of aperture 86 is similar to the cross section shape of projection 46. Sidewall 87 may define an aperture 86 having a varying cross section along its depth (e.g., a tapered aperture, an extruded aperture, a stepped aperture, etc.), or alternatively may define an aperture 86 having a uniform cross section along its depth (e.g., a substantially straight aperture, etc.).

According to a preferred embodiment, the cross section of aperture 86 at second mating surface 82 is sized to be larger than the cross section of projection 46 near end face 52, but smaller than the cross section of projection 46 near base 48. For example, if projection 46 is configured as a hemisphere, the cross section of projection 46 near end face 52 is smaller than the cross section of aperture 86 at second mating surface 82, while the cross section of projection 46 near base 48 is larger than the cross section of aperture 86 at second mating surface 82. Such a configuration may serve as a guide (e.g., pilot, etc.) to axially align projection 46 with aperture 86 as first recliner component 40 is coupled to first plate 80.

To couple first recliner component 40 to first plate 80, projections 46, (outwardly extending from first mating surface 42) are axially aligned with corresponding apertures 86 formed in second mating surface 82 as shown in FIG. 2. The narrowing shape of projections 46 may partially assist in axially aligning projections 46 with apertures 86. In this position, the components may be held together by a clamping or pressing device (not shown in the drawings) or other suitable fixture.

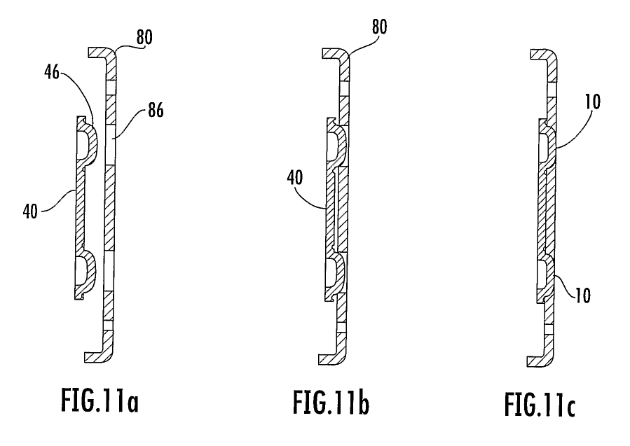

FIGS. 11a through 11c show sequentially the insertion of projection 46 into aperture 86. A force is applied to first recliner component 40 and/or first plate 80 in a direction necessary to insert projections 46 into apertures 86. When a defined pressing force is achieved, a capacitive discharge welding process takes place. In so doing, a molten state is achieved in the interface region (i.e., an area of contact) between projections 46 and apertures 86 (i.e., peripheral surfaces 56 of projections 46 engaging sidewalls 87 of apertures 86) by the high current strength and the high electrical resistance in the contact location so that first recliner component 40 and first plate 80 are pressed together in the position shown in FIG. 11c by means of the pressing device. At substantially the same time, projections 46 are welded with apertures 86. The area of weldment is provided along the outer surface of projection 46 and sidewall 87. The area of weldment is increased due the non-linear peripheral surface 56 of projection 46. Since the heat is applied in the welding region only briefly, the connected first recliner component 40 and first plate 80 are heated only mildly in comparison to other welding processes so that they are substantially free from distortion after the welding process.

During the welding process, material is melted and displaced between first mating surface 42 and second mating surface 82 that can adversely affect the quality of the weld and the overall strength of connection 10 if not allowed to escape or otherwise be removed or repositioned. To account for the formation of this displaced molten material, first recliner component 40 and/or first plate 80 provide a collection system 100 configured to receive at least a portion of the displaced molten material formed during the welding process.

Collection system 100 generally comprises a recess 102 (e.g., groove, cavity, depression, pocket, etc.) having a volume suitable for receiving at least a portion of the molten material displaced during the welding process. The size and shape of recess 102 will depend on the application and the amount of excess material being displaced during the welding process. According to an exemplary embodiment, shown in FIG. 2, recess 102 substantially surrounds the area where projection 46 engages aperture 86. According to one exemplary embodiment, collection system 100 is provided in first mating surface 42 of first recliner component 40 as a recess 102 surrounding projection 46, or alternatively, may be provided in second mating surface 82 of first plate 80 as a recess 102 offset radially from and surrounding aperture 86. Recess 102 may extend continuously around projection 46 and/or aperture 86, or alternatively may extend intermittently around projection 46 and/or aperture 86.

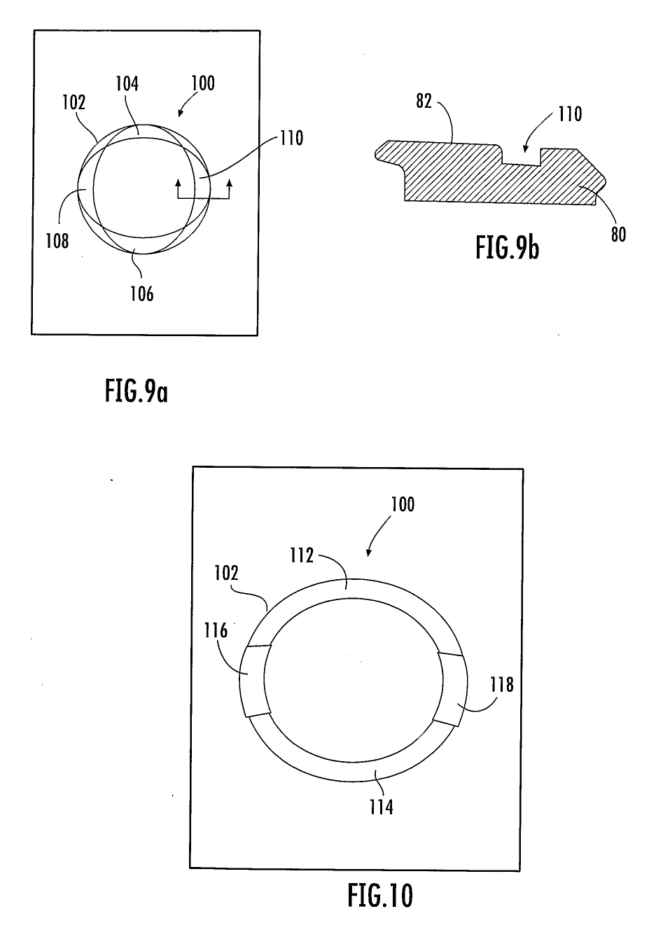

According to another suitable embodiment, a portion of collection system 100 is provided in both first mating surface 42 and second mating surface 82. Referring to FIG. 9a, a collection system 100 wherein first mating surface 42 and second mating surface 82 cooperate to provide a recess 102 suitable for receiving displaced material is shown according to one embodiment. As shown, first mating surface 42 includes a first collection recess 104 and a second collection recess 106, while second mating surface 82 includes a third collection recess 108 and a fourth collection recess 110.

Collection recesses 104 through 108 have a generally crescent shape (e.g., a segment of annular recess having tapering ends). First collection recess 104 surrounds a first or upper side of projection 46, while second collection recess 106 surrounds a second or lower side of projection 46. Similarly, third collection recess 108 surrounds a third or left side of aperture 86, while fourth collection recess 110 surrounds a fourth or left side of aperture 86. In such an embodiment, neither first recliner component 40 nor first plate 80 alone define collection recess 102. Instead, collection recess 102 is only formed when first mating surface 42 of first recliner component 40 is adjacently positioned with second mating surface 82 of first plate 80. Collection recess 102 is shown as being substantially continuous around projection 46 and aperture 86, but alternatively may only be provided intermittently around projection 46 and aperture 86 when first mating surface 42 is adjacently positioned with second mating surface 82.

FIG. 9b shows a cross section of first collection recess 110. First collection recesses 110 is shown as having a cross section that is substantially rectangular. The depth of the recess may remain relatively constant along the segment, or alternatively may vary (e.g., the depth the recess may lesson near the tips of the crescents, etc.). According to other suitable embodiments, the cross sectional shapes of the collection recesses may be any of a variety of suitable shapes (e.g., circular, triangular, defined by linear and curvilinear lines, etc.).

According to a preferred embodiment, first and second collection recesses 104, 106 at least partially overlap third and fourth collection recesses 108, 110 when projection 46 penetrates aperture 86. Overlapping the collection recesses increases the overall volume of collection recess 102 thereby providing additional space to receive material displaced during the welding process.

Referring to FIG. 10, a collection system 100 wherein first mating surface 42 and second mating surface 82 cooperate to provide a recess 102 suitable for receiving displaced material is shown according to another embodiment. In such an embodiment, first mating surface 42 is configured to include a first collection recess 112 and a second collection recess 114, while second mating surface 82 is configured to include a third collection recess 116 and a fourth collection recess 118. Collection recesses 112 through 118 are generally sectorial in shape. The distribution of what portions of collection recess 102 are carried by first recliner component 40 and what portions are carried by first plate 80 may vary depending on the application. Again, in such an embodiment, neither first recliner component 40 nor first plate 80 alone define collection recess 102. Instead, collection recess 102 is only formed when first mating surface 42 of first recliner component 40 is adjacently positioned with second mating surface 82 of first plate 80.

It is important to note that the construction and arrangement of the elements of the structural connection as shown in the illustrated embodiments is illustrative only. Although only a few embodiments of the present invention has been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, or the length or width of the structures and/or members or connectors or other elements of the system may be varied. For example, according to various alternative embodiments, projection 46 may be provided on first plate 80, while aperture 86 is provided on first recliner component 40. According to other suitable embodiments, the elements of connection 10 vary between each connection. For example, at a first connection, first recliner component 40 may include projection 46 and first plate 80 may include aperture 86, while at a second connection, first recliner component 40 may include aperture 86 and first plate 80 may include projection 46. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present inventions. Other substitutions, modifications, changes and omissions may be made in the design, operating conditions and arrangement of the preferred and other exemplary embodiments without departing from the spirit of the appended claims.

The order or sequence of any process or method steps may be varied or resequenced according to alternative embodiments. Any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A connection assembly to be welded, the connection assembly comprising:
a first component having a projection, the projection having a peripheral surface outwardly facing from the first component in a non-linear manner; and
a second component defining an aperture for receiving at least a portion of the projection.

2. The connection assembly of claim 1, wherein the peripheral surface of the projection narrows at a changing rate from a first cross-section at a base of the projection to a second cross-section at a free end of the projection.

3. The connection assembly of claim 2, wherein the aperture has a cross section geometry that is substantially the same as the first cross-section geometry of the projection.

4. The connection assembly of claim 3, wherein the cross-section of the aperture has a first defined area larger than a second defined area of the second cross-section of the projection and smaller than a third defined area of the first cross-section of the projection.

5. The connection assembly of claim 4, wherein a positive mechanical interlock is formed when the projection is pressed into the aperture.

6. The connection assembly of claim 1, wherein the peripheral surface of the projection has a hemispherical shape.

7. The connection assembly of claim 1, wherein the peripheral surface of the projection has a truncated hemispherical shape.

8. The connection assembly of claim 1, further comprising a collection recess at least partially disposed about at least one of the projection and the aperture, the collection recess is configured to receive material displaced when the first component is welded to the second component.

9. The connection assembly of claim 8, wherein the collection recess is an annular groove extending continuously about one of the projection and the aperture.

10. The connection assembly of claim 8, wherein the collection recess includes a first segment in the first component and a second segment in the second component.

11. The connection assembly of claim 10, wherein the first segment and the second segment cooperate to define a substantially continuous annular groove when the projection is received by the aperture.

12. The connection assembly of claim 11, wherein the first segment at least partially overlaps the second segment when the projection is received by the aperture.

13. The connection assembly of claim 1, wherein the first component constitutes one of a component of a vehicular seat recliner and a component of a vehicular seat frame, while the second component constitutes the other of the component of a vehicular seat recliner and the component of a vehicular seat frame.

14. A connection for use in a vehicular seating application, the connection comprising:
a first component having a projection, the projection having a peripheral surface outwardly extending from the first component in a non-linear manner;
a second component defining an aperture for receiving at least a portion of the projection; and
a collection recess at least partially disposed about at least one the projection and the aperture for receiving displaced material when the first component is welded to the second component.

15. The connection assembly of claim 14, wherein the surface of the projection narrows at a changing rate from a first cross-section provided at a base of the projection to a second cross-section provided at a free end of the projection.

16. The connection assembly of claim 14, wherein a positive mechanical interlock is formed when the projection is pressed into the aperture.

17. The connection assembly of claim 14, wherein the collection recess is an annular groove extending continuously about one of the projection and the aperture.

18. A method of coupling a first component to a second component, the method comprising:
pressing a projection provided on the first component into an aperture provided in the second component; and
welding the first component to the second component at an interface between the projection and the aperture, wherein the projection includes a peripheral surface outwardly extending from a first side of the first component in a non-linear manner.

19. The method of claim 18, wherein the step of pressing the projection into the aperture forms a positive mechanical interlock between the first component and the second component.

20. The method of claim 18, wherein the step of welding the first component to the second component involves a capacitive discharge welding process.
